(19) United States
(12) Patent Application Publication
(10) Pub. No.: US 2026/0164087 A1
(43) Pub. Date: Jun. 11, 2026

(54) METHOD AND APPARATUS FOR PROCESSING MEDIA MATERIALS, DEVICE AND PRODUCT

(71) Applicant: Beijing Zitiao Network Technology Co., Ltd., Beijing (CN)

(72) Inventors: Junliang LU, Beijing (CN); Lin WANG, Beijing (CN); Guojin HE, Beijing (CN); Chengling CHEN, Beijing (CN); Fengyi SHANG, Beijing (CN)

(21) Appl. No.: 19/330,672

(22) Filed: Sep. 16, 2025

(30) Foreign Application Priority Data
Dec. 10, 2024 (CN) 202411813421.6

(51) Int. Cl. H04N 21/4402; H04N 21/44; H04N 21/466

(52) U.S. Cl. CPC H04N 21/440281; H04N 21/44016; H04N 21/4665

(57) ABSTRACT

The present disclosure relates to method and apparatus for processing media materials, a device and a product. The method comprises obtaining a first identification of each of a plurality of slots, wherein each of the plurality of slots is used for filling a media material and the first identification is used for indicating whether respective slots belong to a same freeze-frame effect. The method also comprises obtaining a second identification of each of the plurality of slots, wherein the second identification is used for indicating whether respective slots are filled with a same media material. In addition, the method further comprises determining, based on the first identification and the second identification, a freeze-frame combination for media materials, to play the media materials based on the freeze-frame combination, such that a freeze-frame media material in the media materials is continuously displayed for a period of time.

### CROSS-REFERENCE TO RELATED APPLICATION(S)

This application claims priority to Chinese Application No. 202411813421.6, filed on Dec. 10, 2024, the disclosure of which is incorporated herein by reference in its entirety.

### FIELD

The present disclosure relates to computer field, and more specifically to method and apparatus for processing media materials, a device and a product.

### BACKGROUND

Video effects refer to processing video materials with technical means to enhance visual expression and improve viewing experience of the audience. The effects may include, but not limited to, color correction, image transition, addition of effects, animation effects and freeze-frame effects etc. Among them, the freeze-frame effect of the video means that a certain frame of image is frozen and displayed for a period of time, to highlight the key information or create a special atmosphere.

### SUMMARY

In a first aspect of the embodiments of the present disclosure, there is provided a method for processing media materials. The method comprises obtaining a first identification of each of a plurality of slots, wherein each of the plurality of slots is used for filling a media material and the first identification is used for indicating whether respective slots belong to a same freeze-frame effect. The method also comprises obtaining a second identification of each of the plurality of slots, wherein the second identification is used for indicating whether respective slots are filled with a same media material. In addition, the method further comprises determining, based on the first identification and the second identification, a freeze-frame combination for media materials, to play the media materials based on the freeze-frame combination, such that a freeze-frame media material in the media materials is continuously displayed for a period of time.

In a second aspect of the embodiments of the present disclosure, there is provided an apparatus for processing media materials. The apparatus comprises a module for obtaining first identification configured to obtain a first identification of each of a plurality of slots, wherein each of the plurality of slots is used for filling a media material and the first identification is used for indicating whether respective slots belong to a same freeze-frame effect. The apparatus also comprises a module for obtaining second identification configured to obtain a second identification of each of a plurality of slots, wherein the second identification is used for indicating whether respective slots are filled with a same media material. In addition, the apparatus further comprises a module for determining freeze-frame combination configured to determine, based on the first identification and the second identification, a freeze-frame combination for media materials, to play the media materials based on the freeze-frame combination, such that a freeze-frame media material in the media materials is continuously displayed for a period of time.

In a third aspect of the embodiments of the present disclosure, there is provided an electronic device. The electronic device comprises a processor; and a memory coupled to the processor and storing instructions, wherein the instructions, when executed by a processor, cause the electronic device to implement the method according to the first aspect.

In a fourth aspect of the embodiments of the present disclosure, there is provided a computer program product stored thereon with computer-executable instructions, wherein the computer-executable instructions, when executed by a processor, implement the method according to the first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

With reference to the drawings and the following detailed description, the above and other features, advantages and aspects of various embodiments of the present disclosure will become more apparent. In the drawings, same or similar reference signs indicate same or similar elements, wherein:

FIG. 1 illustrates a schematic diagram of an example environment in which a plurality of embodiments of the present disclosure may be implemented;

FIG. 2 illustrates a flowchart of a method for processing media materials in accordance with some embodiments of the present disclosure;

FIGS. 3A-3D illustrate schematic diagrams of editing slots in accordance with some embodiments of the present disclosure;

FIG. 4 illustrates a schematic diagram of an example flow for processing media materials in accordance with some embodiments of the present disclosure;

FIG. 5 illustrates a block diagram of an apparatus for processing media materials in accordance with some embodiments of the present disclosure; and

FIG. 6 illustrates a block diagram of a device capable of implementing a plurality of embodiments of the present disclosure.

### DETAILED DESCRIPTION OF EMBODIMENTS

It is to be appreciated that all user-related data involved in the technical solution should be obtained and used after user authorization. This means that if the personal information of the users is to be used in the technical solution, explicit consent and authorization shall be given by the users before obtaining the personal information; otherwise, related data would not be collected and used. It also should be understood that in implementing the technical solution, one shall strictly follow relevant laws and regulations during collection, usage and storage of the data and take necessary techniques and measures to guarantee user data safety and ensure safe usage of data.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

As stated above, freeze-frame effect may highlight key information of media materials or create a special atmosphere. However, in the related art, when the media materials are configured in the freeze-frame effect, there is a chance that the freeze-frame effect of the media materials could not be displayed correctly. For example, in case that the media material is video content, if an audio track of the video is longer than the video track and users attempt to add the freeze-frame effect to the video within a period of time near a start or an end of the video, it is discovered that the freeze-frame effect could not be correctly displayed.

For this, the present disclosure provides a method for processing media materials to ensure accurate presentation of the freeze-frame effect of the media materials while the media materials are displayed correctly. In order to correctly display the freeze-frame effect of the media materials, it is required to obtain a first identification and a second identification of a slot filled by the media material, wherein the first identification can indicate whether a slot for filling the media material belongs to the same freeze-frame effect and the second identification can represent whether media materials filled into the slots are the same media materials. After the second identifications and the first identifications of the slots for displaying the media materials are obtained, a final freeze-frame combination for the media materials is formed based on the second identifications and the first identifications, such that freeze-frame materials in the media materials can be continuously displayed for a period of time based on the freeze-frame combination while the media materials are being played. In this way, it is ensured that the media materials filled in each slot are correct and the freeze-frame effect for the media materials is displayed normally.

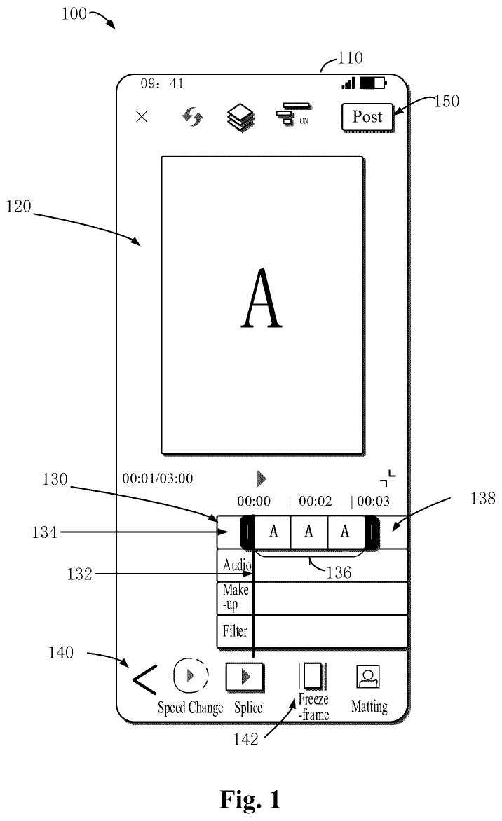

FIG. 1 illustrates a schematic diagram of an example environment 100 in which a plurality of embodiments of the present disclosure may be implemented. As shown in FIG. 1, the media material for example is video material. In a middle area 120 of a display interface 110, real-time footage of the video material A are displayed. Below the middle area 120, a slot 130 of a video track of the video material A for placing or filling the video material is displayed. Below the slot 130 of the video track, an audio track of the video material A and editing tracks which may be added to the video material A by the users through an editing control in an editing control area 140 are displayed. The editing tracks, for example, may be make-up track or filter track, etc.

Continuing to refer to FIG. 1, the users can add the freeze-frame effect to the video material A via a freeze-frame control 142 in the editing control area 140. When the users select the slot 130 of the video track and a touch on the freeze-frame control 142 by the users is detected, the slot 130 of the video track may be split at a play pointer 132 into two video slots, i.e., slot 134 and slot 138 respectively. Meanwhile, the frame of picture pinpointed by the play pointer 132 in the slot 130 of the video track is freeze-framed into a freeze-frame slot 136 (freeze-frame media material slot) of a picture lasting for a period of time (e.g., 3s). The freeze-frame slot is filled with freeze-frame media material and the freeze-frame slot 136 is inserted between the slots 134 and 138. In some embodiments, the users may adjust the time and the relative position of the three slots according to their preferences.

In order to correctly display the freeze-frame effect of the video material A, it is required to obtain first identifications and second identifications of these slots during a preview before the users post the video by clicking a post control 150. In some embodiments, the first identification may be used to determine whether the slots have the same freeze-frame effect. Referring to FIG. 1, if the generation of the slots 134, 136 and 138 is triggered by a touch on the freeze-frame control 142, their first identifications are consistent. In some embodiments, the second identification is used for determining whether the video materials filled in the slots are consistent. With reference to FIG. 1, if the video materials filled in the slots 134, 136 and 138 are consistent, their second identifications are also consistent. In other words, if the slots 134, 136 and 138 are directly obtained through the freeze-frame control 142, their first identifications and second identifications should be consistent.

In some embodiments, after a slot is adjusted or edited, the first identification of the slot would be cleared. In some embodiments, if the video material of a certain slot is cropped, the first identification of the slot of the cropped video material would be cleared while the second identification remains unchanged. In some embodiments, if the video material of a certain slot is replaced, the first identification of the slot with the replaced video material would be cleared and the second identification would also change.

In some embodiments, if a certain slot and the video material filled therein are replicated, the first identification of the slot of the new replicated video material would be cleared while the second identification remains unchanged. In some embodiments, in case that a new slot filled with the video material is added, when the filled video material is the same as the video material filled in a freeze-frame set, the newly added slot has a second identification consistent with that of the slot of the freeze-frame set and lacks a first identification.

In view of the above role of the first identification and the second identification, when the users preview the freeze-frame effect, it is required to first obtain the first identifications and the second identifications of these slots (e.g., slots 134, 136 and 138 shown in FIG. 1) as stated above. Then, it is determined according to the first identifications and the second identifications of these slots whether the slots can be formed into a freeze-frame combination, so as to display the freeze-frame effect to the users based on the freeze-frame combination. In other words, the image of the video material at the play pointer 132 is continuously displayed for a period of time and the image lasting for this period of time is known as the freeze-frame media material, which is filled into the freeze-frame slot, i.e., slot 136.

In some embodiments, when a preview touch by the users is detected, the slots having consistent first identification would be determined first and then combined into a freeze-frame set. If the slots in the freeze-frame set are filled with freeze-frame materials, the slots may be constituted into a freeze-frame combination, so as to display the freeze-frame combination on the display page 110 to the users.

In some embodiments, if the slots having consistent first identification are not found, it may be judged whether the slots have consistent second identification. If their second identifications are consistent and the slots are also filled with freeze-frame media material, these slots may be classified as a first group of slots.

In some embodiments, it is also required to determine whether the slots in the first group of slots apart from the freeze-frame slots (slots filled with the freeze-frame media materials) are continuous and meanwhile, it is also required to determine whether the video materials filled in the slots of the first group of slots apart from the freeze-frame slots are continuous in time. In addition, it is required to determine whether the slots in the first group of slots apart from the freeze-frame slots have consistent second identification in the meantime. If the above conditions are satisfied simultaneously, the first group of slots may be merged into a freeze-frame set. If any of the above conditions is unsatisfied, the slots failing to meet the conditions would be classified as a second group of slots.

In some embodiments, since some slots in the freeze-frame set may be cropped, it is also required to consider correctness of the timeline for presenting the slots in the freeze-frame set to the users. As such, the slot having the minimum starting time in the freeze-frame set is determined and its starting time is used as the reference time; meanwhile, the starting time of other slots in the freeze-frame set is recorded according to the reference time. Of course, the freeze-frame set also includes freeze-frame slots filled with picture material. Subsequently, the video with freeze-frame effect is displayed to the users based on the freeze-frame combination with adjusted timeline.

In this way, it is ensured that the media material filled in each slot is correct and the freeze-frame effects for the media material are displayed normally.

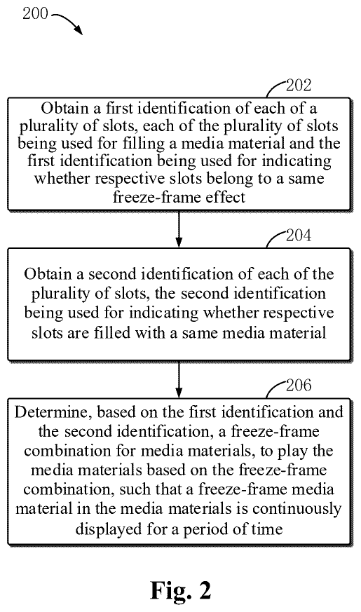

The method according to embodiments of the present disclosure is to be described in details below with reference to FIGS. 2 to 6. To facilitate understanding, the specific data mentioned in the following description are exemplary and shall not restrict the protection scope of the present disclosure. It is to be appreciated that the embodiments described below may include additional acts not shown and/or may omit the illustrated acts. The scope of the present disclosure is not restricted in this regard.

FIG. 2 illustrates a flowchart of a video processing method 200 in accordance with some embodiments of the present disclosure. The method 200 may be executed by an apparatus for processing media materials. The apparatus for example may be an independent apparatus or system. The apparatus may be implemented by software and/or hardware. Next, the method 200 is schematically explained with the apparatus for video processing as the executing entity. The method 200 includes a block 202, a block 204 and a block 206.

As shown in FIG. 2, at block 202, a first identification of each of a plurality of slots is obtained, wherein each of the plurality of slots is used for filling media materials and the first identification indicates whether respective slots belong to a same freeze-frame effect. In order to correctly display the freeze-frame effect for the video material A, it is required to obtain the first identifications of these slots. In some embodiments, the first identification may be used for determining whether these slots have the same freeze-frame effect. Referring to FIG. 1, if the generation of the slots 134, 136 and 138 is triggered by touching the freeze-frame control 142, their first identifications are consistent.

At block 204, a second identification of each of the plurality of slots is obtained, wherein the second identification is used for indicating whether respective slots are filled with a same media material. In order to correctly display the freeze-frame effect for the video material A, it is also required to obtain the second identifications of these slots. In some embodiments, the second identification is provided for determining whether the video materials filled in the slots are consistent. Referring to FIG. 1, if the video materials filled into the slots 134, 136 and 138 are consistent, their second identifications are also consistent.

At block 206, based on the first identification and the second identification, the freeze-frame combination of a media material is determined for playing the media materials according to the freeze-frame combination, such that the freeze-frame media material in the media materials is continuously displayed for a period of time. With reference to FIG. 1, after the first identification and the second identification of the slot (e.g., slot 134, slot 136 and slot 138 in FIG. 1) is obtained, the slots having consistent first identification may be determined first and then combined into the freeze-frame set. If these slots in the freeze-frame set are filled with the freeze-frame materials, the slots are constituted into a freeze-frame combination, so as to display the freeze-frame combination on the display interface 110 to the users.

In some embodiments, if the slots having consistent first identification are not found, it may be determined whether the second identifications of these slots are consistent. If the second identifications are consistent and these slots are also filled with the freeze-frame media materials, these slots may be classified as In some embodiments, it is also required to determine whether the slots in the first the first group of slots, group of slots apart from the freeze-frame slots (slots filled with the freeze-frame media materials) are continuous and meanwhile, it is also required to judge whether the video materials filled in the slots of the first group of slots apart from the freeze-frame slots are continuous in time. In addition, it is required to judge whether the slots in the first group of slots apart from the freeze-frame slots have consistent second identifications at the meantime. If the above conditions are satisfied simultaneously, the first group of slots may be merged into a freeze-frame set. If any of the above conditions is unsatisfied, the slots failing to meet the conditions would be classified as a second group of slots.

In some embodiments, since some slots in the freeze-frame set may be cropped, it is also required to consider correctness of the timeline for presenting the slots in the freeze-frame set to the users. As such, the slot having the minimum starting time in the freeze-frame set is determined and its starting time is used as the reference time; meanwhile, the starting time of other slots in the freeze-frame set is recorded according to the reference time. Of course, the freeze-frame set also includes freeze-frame slots filled with picture material. Subsequently, the video with freeze-frame effect is displayed to the users based on the freeze-frame combination with adjusted timeline.

In this way, it is ensured that the media material filled in each slot is correct and the freeze-frame effects for the media material are displayed normally.

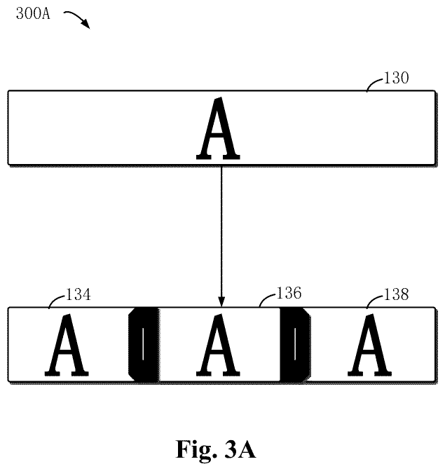

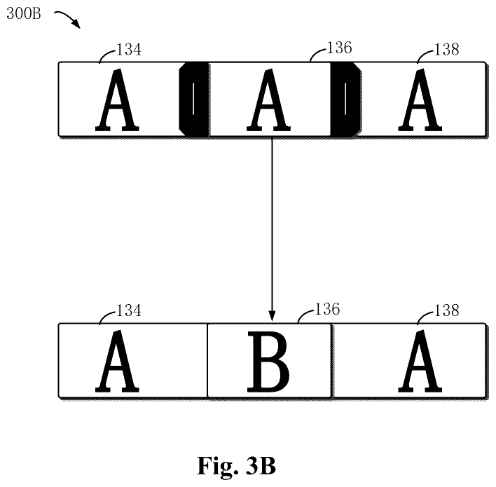

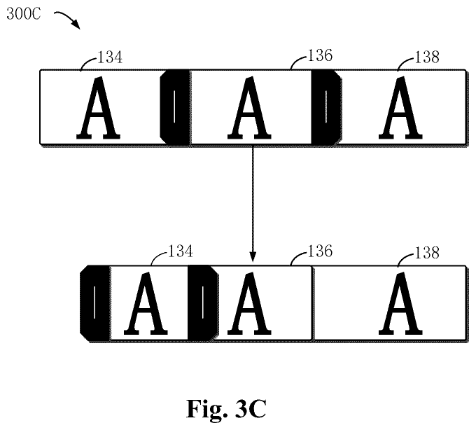

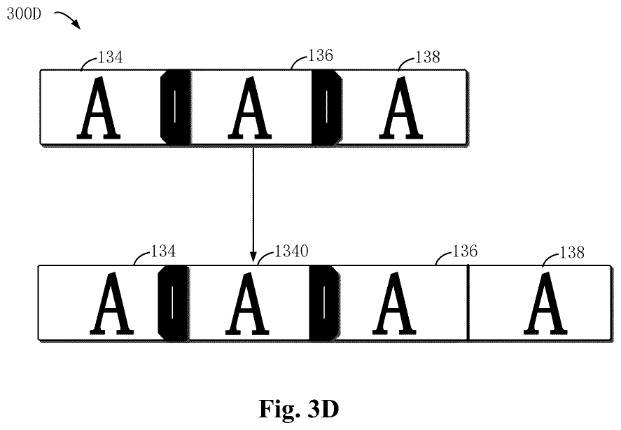

FIG. 3A illustrates a schematic diagram of generating three slots 300A in the freeze-frame set in accordance with some embodiments of the present disclosure. Referring to FIG. 3A, the video material A is filled in the slot 130. By a touch on the freeze-frame control by the users, the slot 130 may be split at the play pointer designated by the users into the slot 134 and the slot 138, wherein each slot is filled with a corresponding portion of the video material A; and the media materials filled in the slots 134 and 138 are continuous in time.

Meanwhile, a new picture slot 136 is also generated between the slots 134 and 138 for filling the freeze-frame video material, and the freeze-frame video material may be in a form of freeze-framing a frame of picture in the video material A designated by the users through the play pointer for a period of time, i.e., this frame of picture is continuously displayed for a period of time. In such case, since the slots 134, 136 and 138 are in the same freeze-frame set and belong to the same freeze-frame effect, their first identifications are consistent. For example, their first identifications are all X. Meanwhile, the slots 134, 136 and 138 are filled with the video material A, so their second identifications are also consistent. For example, their second identifications are all Y, as illustrated in Table 1:

TABLE 1

| | Slot 134 | (Freeze-Frame) Slot 136 | Slot 138 |
|---|---|---|---|
| First identification | X | X | X |
| Second | Y | Y | Y |
| identification | | | |

FIG. 3B illustrates a schematic diagram of replacing materials 300B in the slots in accordance with some embodiments of the present disclosure. Referring to FIG. 3B, original slots 134, slot 136 and slot 138 are directly generated based on the freeze-frame control and have the same freeze-frame effect. Their first identifications are all X and their second identifications are all Y. In some embodiments, the slot 136 in the original freeze-frame set is filled with the video material A, which is then replaced by the video material B. As a result, the first identifications of the slots 134, 136 and 138 are inconsistent. For example, the first identifications of the slots 134 and 138 are X while the first identification of the slot 136 is cleared. Meanwhile, the second identifications of the slots 134 and 138 are Y while the second identification of the slot 136 is reset to Y1 as illustrated in Table 2:

TABLE 2

| Replacement | Slot 134 | (Freeze-Frame) Slot 136 | Slot 138 |
|---|---|---|---|
| First identification | X | Cleared | X |
| Second | Y | Y1 | Y |
| identification | | | |

FIG. 3C illustrates a schematic diagram of cropping a slot and a material 300C therein in accordance with some embodiments of the present disclosure. Referring to FIG. 3C, original slots 134, slot 136 and slot 138 are directly generated based on the freeze-frame control and belong to the same freeze-frame set. Their first identifications are all X and their second identifications are all Y. In some embodiments, the length of the material filled in the slot 134 of the original freeze-frame set is cropped and the corresponding length of the slot would also be cropped. As such, the first identifications of the slots 134, 136 and 138 are inconsistent. For example, the first identifications of the slots 136 and 138 are X while the first identification of the slot 134 is cleared. Meanwhile, the slot 134, slot 136 and slot 138 are all filled with the video material A, so their second identifications are all Y as illustrated in Table 3:

TABLE 3

| Cropping | Slot 134 | (Freeze-Frame) Slot 136 | Slot 138 |
|---|---|---|---|
| First identification | Cleared | X | X |
| Second | Y | Y | Y |
| identification | | | |

FIG. 3D illustrates a schematic diagram of replicating slot 300D in accordance with some embodiments of the present disclosure. With reference to FIG. 3D, original slots 134, slot 136 and slot 138 are directly generated based on the freeze-frame control and have the same freeze-frame effect. Their first identifications are all X and their second identifications are all Y. In some embodiments, the material filled in the slot 134 in the original freeze-frame set is replicated and filled into the slot 1340. In such case, the first identifications of the slots 134, 1340, 136 and 138 are inconsistent. For example, the first identifications of the slots 134, 136 and 138 are X while the slot 1340 does not have a first identification. Meanwhile, the slots 134, 1340, 136 and 138 are all filled with the video material A, so their second identifications are all Y as illustrated in Table 4:

TABLE 4

| Replication | Slot 134 | Slot 1340 | (Freeze-Frame) Slot 136 | Slot 138 |
|---|---|---|---|---|
| First | X | Null | X | X |
| identification | | | | |
| Second | Y | Y | Y | Y |
| identification | | | | |

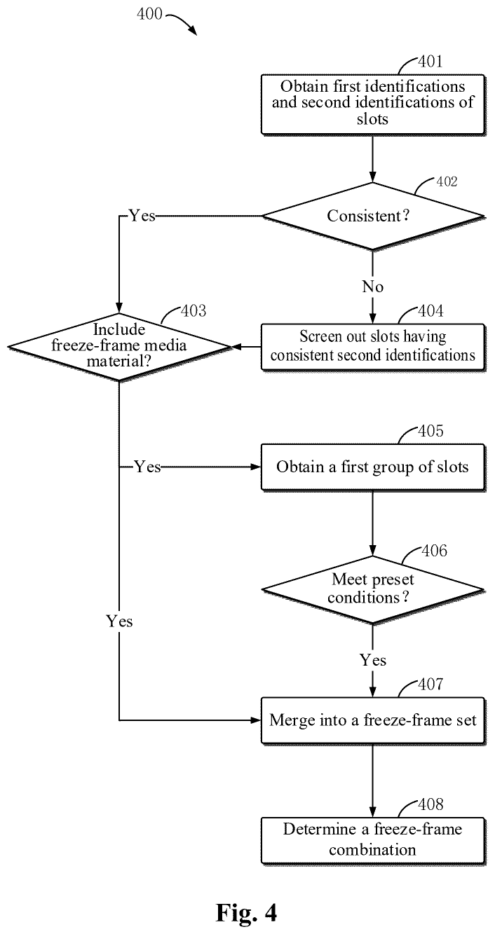

FIG. 4 illustrates a schematic diagram of an example flow 400 for processing media materials in accordance with some embodiments of the present disclosure. In order to correctly display the freeze-frame effect for the video material A, it is required to obtain the first identification and the second identification of the slot during the preview by the users because the slot stores the video material A and material with freeze-frame effect. With reference to FIG. 4, the first identification and the second identification of the slot are obtained at 401. In conjunction with FIG. 1, it is required to obtain the first identifications and the second identifications of the slots 134, 136 and 138 first.

According to FIG. 4, after the first identifications and the second identifications of the slots are obtained, it may be judged at 402 whether the first identifications of the slots are consistent. As a result, there may be two scenarios, i.e., one scenario in which the first identifications of the slots are consistent and the other scenario where the first identifications of the slots are inconsistent. With reference to Tables 1-4, the first identifications of the slots 134, 136 and 138 are all X and their second identifications are all Y in Table 1, which belongs to the scenario where the first identifications of the slots are consistent. However, Tables 2-4 all demonstrate the scenario where the first identifications of the slots 134, 136 and 138 are inconsistent.

Next, the scenario where the first identifications of the slots are consistent is depicted first. With reference to Table 1, the first identifications of the slots 134, 136 and 138 are all X, i.e., the judgment for 402 of FIG. 4 is positive. It is then judged at 403 whether the slots contain freeze-frame media materials. If yes, the slots are merged into the freeze-frame set at 407, i.e., the slots 134, 136 and 138 belong to a freeze-frame set and the slot 136 in the freeze-frame set is also filled with the freeze-frame video materials. Therefore, the freeze-frame effect for the video material A may be displayed to the users on the display interface 110 shown in FIG. 1.

The scenario where the first identifications of the slots are inconsistent is to be described below. With reference to Table 2, the first identifications of the slots 134, 136 and 138 are inconsistent, i.e., the judgement for 402 of FIG. 4 is negative. Then, the slots having consistent second identification may be screened out at 404. According to Table 2, among these slots, the slots 134 and 138 have consistent second identification and the material in the slot 136 between the slots 134 and 138 is not the freeze-frame video material. That is, the judgement for 403 is negative, and the condition for merging into the freeze-frame set is unsatisfied. Therefore, the slot 136 may be classified into the second group of slots.

The following description is made with reference to Table 3. As shown in Table 3, the first identifications of the slots 134, 136 and 138 are inconsistent, i.e., the judgment for 402 of FIG. 4 is negative. Then, the slots having consistent second identification may be screened out at 404. In conjunction with Table 2, the second identifications of the slots 134, 136 and 138 are consistent and the slot 136 is filled with the freeze-frame material. As such, the judgment for 403 is positive and the first group of slots is obtained at 405, i.e., the slots 134, 136 and 138 are classified into the first group of slots.

Continuing to refer to FIG. 4, after the first group of slots are obtained, it is also required to traverse to judge whether respective slots in the first group of slots apart from the freeze-frame slot 136 meet a preset condition at 406. For example, it is required to judge whether each slot apart from the freeze-frame slot has a consistent second identification. Meanwhile, it is required to judge whether the sequence of the slots apart from the freeze-frame slot is continuous and whether the video materials filled in the slots apart from the freeze-frame slot are continuous. When a judgment is made as to whether the slots are continuous and whether the materials in the slots are continuous, the related contents of the freeze-frame slot are not considered. Therefore, the freeze-frame slot may be ignored to simplify the calculation. With reference to the above description of Table 3, slots 134 and 138 both satisfy the above conditions, i.e., the judgment for 406 is positive and the slots 134, 136 and 138 may be merged into one freeze-frame set at 407.

Meanwhile, as stated above, the slot 134 in Table 3 has been cropped, so it is also required to adjust the timestamp of each slot in the freeze-frame set. In some embodiments, the starting time of the slot ranked first according to the time sequence in the freeze-frame set may be used as the reference time, and the starting time of each slot in the freeze-frame set is recorded simultaneously. Then, the starting timestamp of each slot is re-determined based on a difference between the original starting timestamp of each slot and the reference time. In other words, the entire freeze-frame set is shifted in time sequence by a distance of a duration of the cropped slot towards the time start point. Therefore, the slots 134, 136 and 138 with adjusted relative positions may be determined at 408 as the freeze-frame effects for the video material A displayed to the users on the display interface 110 shown in FIG. 1. The method with the aid of the first identification and the second identification can ensure the accurate presentation of the freeze-frame effects of the media materials while correctly displaying the media materials.

The following description is made with reference to Table 4. The first identifications of the slots 134, 1340, 136 and 138 are inconsistent as shown in Table 4, i.e., the judgment for 402 of FIG. 4 is negative and the slots having consistent second identification may be screened out at 404. In conjunction with Table 2, the second identifications of the slots 134, 1340, 136 and 138 are consistent and the slot 136 is filled with the freeze-frame material. That is, the judgment for 403 is positive and the first group of slots may be obtained at 405. The slots 134, 1340, 136 and 138 are accordingly classified as the first group of slots.

Referring to FIG. 4, after the first group of slots are obtained, it is also required to traverse to judge whether respective slots in the first group of slots apart from the freeze-frame slot 136 meet a preset condition at 406. For example, it is required to judge whether each slot apart from the freeze-frame slot has a consistent second identification. Meanwhile, it is required to judge whether the sequence of the slots apart from the freeze-frame slot is continuous and whether the video materials filled in the slots apart from the freeze-frame slot are continuous. When a judgment is made as to whether the slots are continuous and whether the materials in the slots are continuous, the related contents of the freeze-frame slot are not considered. Therefore, the freeze-frame slot may be ignored to simplify the calculation.

In view of the above description of Table 4, slots 134, 1340 and 138 all satisfy the above conditions, i.e., the judgment for 406 is positive and the slots 134, 1340, 136 and 138 may be merged into a freeze-frame set at 407. Since no adjustments are made to the lengths of the sots 134, 1340, 136 and 138, these slots may be determined as a freeze-frame combination at 408, so as to display the freeze-frame effects for the video material A to the users on the display interface 110 shown in FIG. 1. The method with the aid of the first identification and the second identification can ensure the accurate presentation of the freeze-frame effects of the media materials while correctly displaying the media materials.

The method with the aid of the first identification and the second identification can ensure the accurate presentation of the freeze-frame effects of the media materials while correctly displaying the media materials.

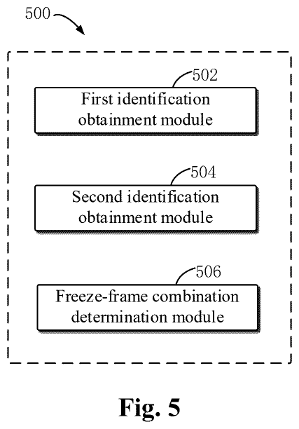

FIG. 5 illustrates a block diagram of a video processing apparatus 500 in accordance with some embodiments of the present disclosure. As shown in FIG. 5, the apparatus 500 comprises a first identification obtainment module 502 configured to obtain a first identification of each of a plurality of slots, each of the plurality of slots being used for filling a media material and the first identification being used for indicating whether respective slots belong to a same freeze-frame effect. The apparatus 500 also comprises a second identification obtainment module 504 for configured to obtain a second identification of each slot of a plurality of slots, the second identification being used for indicating whether respective slots are filled with a same media material. In addition, the apparatus 500 further comprises a freeze-frame combination determination module 506 configured to determine, based on the first identification and the second identification, a freeze-frame combination for media materials, to play the media materials based on the freeze-frame combination, such that a freeze-frame media material in the media materials is continuously displayed for a period of time.

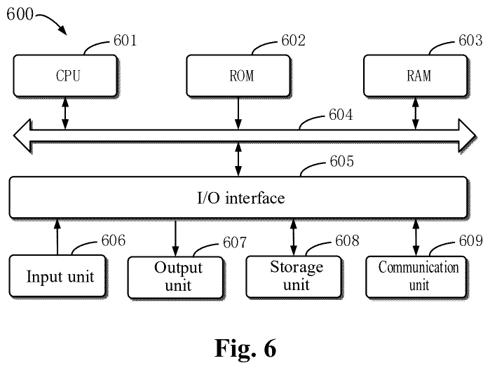

FIG. 6 illustrates a block diagram of a device 600 capable of implementing a plurality of embodiments of the present disclosure. As shown in FIG. 6, the device 600 comprises a central processing unit (CPU) and/or graphics processing unit (GPU) 601, which can execute various suitable actions and processing based on the computer program instructions stored in the read-only memory (ROM) 602 or computer program instructions loaded in the random-access memory (RAM) 603 from the storage unit 608. The RAM 603 can also store all kinds of programs and data required by the operation of the device 600. CPU/GPU 601, ROM 602 and RAM 603 are connected to each other via a bus 604. The input/output (I/O) interface 605 is also connected to the bus 604. Although not illustrated in FIG. 6, the device 600 also may include a coprocessor.

A plurality of components in the device 600 are connected to the I/O interface 605, including: an input unit 606, such as keyboard, mouse and the like; an output unit 607, e.g., various kinds of display and loudspeakers etc.; a storage unit 608, such as disk and optical disk etc.; and a communication unit 609, such as network card, modem, wireless transceiver and the like. The communication unit 609 allows the device 600 to exchange information/data with other devices via the computer network, such as Internet, and/or various telecommunication networks.

The above described respective methods can be executed by the GPU/CPU 601. For example, in some embodiments, the method can be implemented as a computer software program tangibly included in the machine-readable medium, e.g., storage unit 608. In some embodiments, the computer program can be partially or fully loaded and/or mounted to the apparatus 600 via ROM 602 and/or communication unit 609. When the computer program is loaded to RAM 603 and executed by the CPU/GPU 601, one or more steps or actions of the above described method or procedure may be executed.

In some embodiments, the above described method and procedure may be implemented as a computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, gateway computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages and traditional procedural programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by device, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

Some example implementations are listed below.

Example 1. A method for processing media materials, comprising:
obtaining a first identification of each of a plurality of slots, each of the plurality of slots being used for filling a media material, the first identification being used for indicating whether respective slots belong to a same freeze-frame effect;
obtaining a second identification of each of the plurality of slots, the second identification being used for indicating whether respective slots are filled with a same media material; and
determining, based on the first identification and the second identification, a freeze-frame combination for media materials, to play the media materials based on the freeze-frame combination, such that a freeze-frame media material in the media materials is continuously displayed for a period of time.

Example 2. The method of Example 1, wherein determining, based on the first identification and the second identification, the freeze-frame combination for the media materials comprises:
in response to first identifications of the plurality of slots being consistent, determining a freeze-frame set based on the consistent first identification, the freeze-frame set consisting of a plurality of slots with the consistent first identifications; and
in response to media materials filled in the plurality of slots in the freeze-frame set comprising the freeze-frame media material, determining the freeze-frame combination for the media materials based on the freeze-frame set.

Example 3. The method of any of Examples 1-2, wherein determining, based on the first identification and the second identification, the freeze-frame combination for the media materials comprises:
in response to first identifications of the plurality of slots being inconsistent, determining whether the plurality of slots have consistent second identifications;
determining whether the media materials filled in the plurality of slots comprise the freeze-frame media material; and
in response to the plurality of slots having consistent second identifications and the media materials filled in the plurality of slots comprising the freeze-frame media material, determining a first group of slots.

Example 4. The method of any of Examples 1-3, further comprising:
traversing each slot in the first group of slots; and
in response to media materials filled in a plurality of slots of the first group of slots apart from a freeze-frame media material slot being temporally continuous, and in response to the plurality of slots of the first group of slots apart from the freeze-frame media material slot being continuous, and in response to second identifications of the plurality of slots of the first group of slots apart from the freeze-frame media material slot being consistent, merging the plurality of slots of the first group of slots into a freeze-frame set including the freeze-frame media material slot.

Example 5. The method of any of Examples 1-4, further comprising:
determining a starting time of a slot having a minimum timestamp in the freeze-frame set as a reference time; and
determining the starting time of each slot in the freeze-frame set based on the reference time.

Example 6. The method of any of Examples 1-5, further comprising:
determining the freeze-frame combination for the media materials based on the starting time of each slot and the freeze-frame set.

Example 7. The method of any of Examples 1-6, further comprising:
in response to failing to meet media materials filled in the plurality of slots of the first group of slots apart from the freeze-frame media material slot being temporally continuous, or in response to failing to meet the plurality of slots of the first group of slots apart from the freeze-frame media material slot being continuous, or in response to failing to meet the second identifications of the plurality of slots of the first group of slots apart from the freeze-frame media material slot being consistent, classifying slots failing to meet conditions as a second group of slots.

Example 8. The method of any of Examples 1-7, further comprising:
in response to detecting a touch on a first control by a user, splitting a slot of the media material into two slots based on a play pointer;
generating a freeze-frame media material slot between the two slots, the freeze-frame media material being filled with a freeze-frame media material; and
determining a first identification and a second identification of each slot, wherein first identifications and second identifications of the two slots and the freeze-frame media material slot are consistent.

Example 9. The method of any of Examples 1-8, further comprising:
in response to detecting a touch on a second control of a slot by a user, replacing a media material filled in the slot;
re-determining the second identification of the slot with the replaced media material; and
clearing a first identification of the slot with replaced media material.

Example 10. The method of any of Examples 1-9, further comprising:
in response to detecting a touch on a third control of the slot by a user, cropping a media material filled in the slot;
keeping a second identification of the slot with cropped media material unchanged; and
clearing a first identification of the slot with cropped media material.

Example 11. The method of any of Examples 1-10, further comprising:
in response to detecting a touch on a fourth control of the slot by a user, replicating the slot and a media material filled in the slot;
re-determining a second identification of the replicated slot; and
clearing a first identification of the replicated slot.

Example 12. The method of any of Examples 1-11, further comprising:
in response to detecting a touch on a fifth control of the slot by a user, determining a first identification and a second identification of the added slot.

Example 13. The method of any of Examples 1-12, further comprising:
in response to detecting a touch on a sixth control by a user, playing the processed media material based on the freeze-frame combination, such that the freeze-frame media material in the media materials is continuously displayed for a period of time during play.

Example 14. An apparatus for video processing, comprising:
a first identification obtainment module configured to obtain a first identification of each of a plurality of slots, each of the plurality of slots being used for filling a media material, the first identification being used for indicating whether respective slots belong to a same freeze-frame effect;
a second identification obtainment module configured to obtain a second identification of each of a plurality of slots, the second identification being used for indicating whether respective slots are filled with a same media material; and
a freeze-frame combination determination module configured to determine, based on the first identification and the second identification, a freeze-frame combination for media materials, to play the media materials based on the freeze-frame combination, such that a freeze-frame media material in the media materials is continuously displayed for a period of time.

Example 15. The apparatus of Example 14, wherein the freeze-frame combination determination includes:
a first freeze-frame set determination module configured to, in response to first identifications of the plurality of slots being consistent, determine a freeze-frame set based on the consistent first identification, the freeze-frame set consisting of a plurality of slots with the consistent first identifications; and
a first freeze-frame combination determination module configured to, in response to media materials filled in the plurality of slots in the freeze-frame set comprising the freeze-frame media material, determine the freeze-frame combination for the media materials based on the freeze-frame set.

Example 16. The apparatus of any of Examples 14-15, wherein the freeze-frame combination determination module includes:
a first determination module configured to, in response to first identifications of the plurality of slots being inconsistent, determine whether the plurality of slots have consistent second identifications;
a second determination module configured to determine whether the media materials filled in the plurality of slots comprise the freeze-frame media material; and
a third determination module configured to, in response to the plurality of slots having consistent second identifications and the media materials filled in the plurality of slots comprising the freeze-frame media material, determine a first group of slots.

Example 17. The apparatus of any of Examples 14-16, further comprising:
a traversal module configured to traverse each slot in the first group of slots; and
a first merger module configured to, in response to media materials filled in a plurality of slots of the first group of slots apart from a freeze-frame media material slot being temporally continuous, and in response to the plurality of slots of the first group of slots apart from the freeze-frame media material slot being continuous, and in response to second identifications of the plurality of slots of the first group of slots apart from the freeze-frame media material slot being consistent, merge the plurality of slots of the first group of slots into a freeze-frame set including the freeze-frame media material slot.

Example 18. The apparatus of any of Examples 14-17, further comprising:
a fourth determination module configured to determine a starting time of a slot having a minimum timestamp in the freeze-frame set as a reference time; and
a fifth determination module configured to determine the starting time of each slot in the freeze-frame set based on the reference time.

Example 19. The apparatus of any of Examples 14-18, further comprising:
a sixth determination module configured to determine the freeze-frame combination for the media materials based on the starting time of each slot and the freeze-frame set.

Example 20. The apparatus of any of Examples 14-19, further comprising:
a first classification module configured to, in response to failing to meet media materials filled in the plurality of slots of the first group of slots apart from the freeze-frame media material slot being temporally continuous, or in response to failing to meet the plurality of slots of the first group of slots apart from the freeze-frame media material slot being continuous, or in response to failing to meet the second identifications of the plurality of slots of the first group of slots apart from the freeze-frame media material slot being consistent, classify slots failing to meet conditions as a second group of slots.

Example 21. The apparatus of any of Examples 14-20, further comprising:
a split module configured to, in response to detecting a touch on a first control by a user, split a slot of the media material into two slots based on a play pointer;
a first generation module configured to generate a freeze-frame media material slot between the two slots, the freeze-frame media material being filled with a freeze-frame media material; and
a seventh determination module configured to determine a first identification and a second identification of each slot, wherein first identifications and second identifications of the two slots and the freeze-frame media material slot are consistent.

Example 22. The apparatus of any of Examples 14-21, further comprising:
a replacement module configured to, in response to detecting a touch on a second control of a slot by a user, replace a media material filled in the slot;
an eighth determination module configured to re-determine the second identification of the slot with the replaced media material; and
a first clarity module configured to clear a first identification of the slot with replaced media material.

Example 23. The apparatus of any of Examples 14-22, further comprising:
a cropping module configured to, in response to detecting a touch on a third control of the slot by a user, crop a media material filled in the slot;
a keeping module configured to keep a second identification of the slot with cropped media material unchanged; and
a second clarity module configured to clear a first identification of the slot with cropped media material.

Example 24. The apparatus of any of Examples 14-23, further comprising:
a replication module configured to, in response to detecting a touch on a fourth control of the slot by a user, replicate the slot and a media material filled in the slot;
a ninth determination module configured to re-determine a second identification of the replicated slot; and
a third clarity module configured to clear a first identification of the replicated slot.

Example 25. The apparatus of any of Examples 14-24, further comprising:
a tenth determination module configured to, in response to detecting a touch on a fifth control of the slot by a user, determine a first identification and a second identification of the added slot.

Example 26. The apparatus of any of Examples 14-24, further comprising:
a playback module configured to, in response to detecting a touch on a sixth control by a user, play the processed media material based on the freeze-frame combination, such that the freeze-frame media material in the media materials is continuously displayed for a period of time during play.

Example 27. An electronic device, comprising:
a processor; and
a memory coupled to the processor and having instructions stored therein, wherein the instructions, when executed by a processor, cause the electronic device to perform acts including:
obtaining a first identification of each of a plurality of slots, each of the plurality of slots being used for filling a media material, the first identification being used for indicating whether respective slots belong to a same freeze-frame effect;
obtaining a second identification of each of the plurality of slots, the second identification being used for indicating whether respective slots are filled with a same media material; and
determining, based on the first identification and the second identification, a freeze-frame combination for media materials, to play the media materials based on the freeze-frame combination, such that a freeze-frame media material in the media materials is continuously displayed for a period of time.

Example 28. The electronic device of Example 27, wherein determining, based on the first identification and the second identification, the freeze-frame combination for the media materials comprises:
in response to first identifications of the plurality of slots being consistent, determining a freeze-frame set based on the consistent first identification, the freeze-frame set consisting of a plurality of slots with the consistent first identifications; and
in response to media materials filled in the plurality of slots in the freeze-frame set comprising the freeze-frame media material, determining the freeze-frame combination for the media materials based on the freeze-frame set.

Example 29. The electronic device of any of Examples 27-28, wherein determining, based on the first identification and the second identification, the freeze-frame combination for the media materials comprises:
in response to first identifications of the plurality of slots being inconsistent, determining whether the plurality of slots have consistent second identifications;
determining whether the media materials filled in the plurality of slots comprise the freeze-frame media material; and
in response to the plurality of slots having consistent second identifications and the media materials filled in the plurality of slots comprising the freeze-frame media material, determining a first group of slots.

Example 30. The electronic device of any of Examples 27-29, further comprising:
traversing each slot in the first group of slots; and
in response to media materials filled in a plurality of slots of the first group of slots apart from a freeze-frame media material slot being temporally continuous, and in response to the plurality of slots of the first group of slots apart from the freeze-frame media material slot being continuous, and in response to second identifications of the plurality of slots of the first group of slots apart from the freeze-frame media material slot being consistent, merging the plurality of slots of the first group of slots into a freeze-frame set including the freeze-frame media material slot.

Example 31. The electronic device of any of Examples 27-30, further comprising:
determining a starting time of a slot having a minimum timestamp in the freeze-frame set as a reference time; and
determining the starting time of each slot in the freeze-frame set based on the reference time.

Example 32. The electronic device of any of Examples 27-31, further comprising:
determining the freeze-frame combination for the media materials based on the starting time of each slot and the freeze-frame set.

Example 33. The electronic device of any of Examples 27-32, further comprising:
in response to failing to meet media materials filled in the plurality of slots of the first group of slots apart from the freeze-frame media material slot being temporally continuous, or in response to failing to meet the plurality of slots of the first group of slots apart from the freeze-frame media material slot being continuous, or in response to failing to meet the second identifications of the plurality of slots of the first group of slots apart from the freeze-frame media material slot being consistent, classifying slots failing to meet conditions as a second group of slots.

Example 34. The electronic device of any of Examples 27-33, further comprising:
in response to detecting a touch on a first control by a user, splitting a slot of the media material into two slots based on a play pointer;
generating a freeze-frame media material slot between the two slots, the freeze-frame media material being filled with a freeze-frame media material; and
determining a first identification and a second identification of each slot, wherein first identifications and second identifications of the two slots and the freeze-frame media material slot are consistent.

Example 35. The electronic device of any of Examples 27-34, further comprising:
in response to detecting a touch on a second control of a slot by a user, replacing a media material filled in the slot;
re-determining the second identification of the slot with the replaced media material; and
clearing a first identification of the slot with replaced media material.

Example 36. The electronic device of any of Examples 27-35, further comprising:
in response to detecting a touch on a third control of the slot by a user, cropping a media material filled in the slot;
keeping a second identification of the slot with cropped media material unchanged; and
clearing a first identification of the slot with cropped media material.

Example 37. The electronic device of any of Examples 27-36, further comprising:
in response to detecting a touch on a fourth control of the slot by a user, replicating the slot and a media material filled in the slot;
re-determining a second identification of the replicated slot; and
clearing a first identification of the replicated slot.

Example 38. The electronic device of any of Examples 27-37, further comprising:
in response to detecting a touch on a fifth control of the slot by a user, determining a first identification and a second identification of the added slot.

Example 39. The electronic device of any of Examples 27-38, further comprising:
in response to detecting a touch on a sixth control by a user, playing the processed media material based on the freeze-frame combination, such that the freeze-frame media material in the media materials is continuously displayed for a period of time during play.

Example 40. A computer-readable storage medium on which computer-executable instructions are stored, wherein the computer-executable instructions, when executed by a processor, implement the method according to any of Examples 1-13.

Example 41. A computer program product tangibly stored on a non-transitory computer-readable medium and including computer-executable instructions, wherein the computer-executable instructions, when executed by a device, cause the device to implement the method according to any of Examples 1-13.

Although the present disclosure has been described in a language specific to structural features and/or logical actions of the methods, it should be understood that the subject matter defined in the appended claims is not necessarily limited to the specific features or actions described above. On the contrary, the specific features and actions described above are only exemplary forms for implementing the claims.

I/We claim:

1. A method for processing media materials, comprising:
obtaining a first identification of each of a plurality of slots, each of the plurality of slots being used for filling a media material, the first identification being used for indicating whether respective slots belong to a same freeze-frame effect;
obtaining a second identification of each of the plurality of slots, the second identification being used for indicating whether respective slots are filled with a same media material; and
determining, based on the first identification and the second identification, a freeze-frame combination for media materials, to play the media materials based on the freeze-frame combination, such that a freeze-frame media material in the media materials is continuously displayed for a period of time.

2. The method of claim 1, wherein determining, based on the first identification and the second identification, the freeze-frame combination for the media materials comprises:
in response to first identifications of the plurality of slots being consistent, determining a freeze-frame set based on the consistent first identification, the freeze-frame set consisting of a plurality of slots with the consistent first identifications; and
in response to media materials filled in the plurality of slots in the freeze-frame set comprising the freeze-frame media material, determining the freeze-frame combination for the media materials based on the freeze-frame set.

3. The method of claim 1, wherein determining, based on the first identification and the second identification, the freeze-frame combination for the media materials comprises:
in response to first identifications of the plurality of slots being inconsistent, determining whether the plurality of slots have consistent second identifications;
determining whether the media materials filled in the plurality of slots comprise the freeze-frame media material; and
in response to the plurality of slots having consistent second identifications and the media materials filled in the plurality of slots comprising the freeze-frame media material, determining a first group of slots.

4. The method of claim 3, further comprising:
traversing each slot in the first group of slots; and
in response to media materials filled in a plurality of slots of the first group of slots apart from a freeze-frame media material slot being temporally continuous, and in response to the plurality of slots of the first group of slots apart from the freeze-frame media material slot being continuous, and in response to second identifications of the plurality of slots of the first group of slots apart from the freeze-frame media material slot being consistent, merging the plurality of slots of the first group of slots into a freeze-frame set including the freeze-frame media material slot.

5. The method of claim 4, further comprising:
determining a starting time of a slot having a minimum timestamp in the freeze-frame set as a reference time; and
determining the starting time of each slot in the freeze-frame set based on the reference time.

6. The method of claim 5, further comprising:
determining the freeze-frame combination for the media materials based on the starting time of each slot and the freeze-frame set.

7. The method of claim 6, further comprising:
in response to failing to meet media materials filled in the plurality of slots of the first group of slots apart from the freeze-frame media material slot being temporally continuous, or in response to failing to meet the plurality of slots of the first group of slots apart from the freeze-frame media material slot being continuous, or in response to failing to meet the second identifications of the plurality of slots of the first group of slots apart from the freeze-frame media material slot being consistent, classifying slots failing to meet conditions as a second group of slots.

8. The method of claim 1, further comprising:
in response to detecting a touch on a first control by a user, splitting a slot of the media material into two slots based on a play pointer;
generating a freeze-frame media material slot between the two slots, the freeze-frame media material being filled with a freeze-frame media material; and
determining a first identification and a second identification of each slot, wherein first identifications and second identifications of the two slots and the freeze-frame media material slot are consistent.

9. The method of claim 1, further comprising:
in response to detecting a touch on a second control of a slot by a user, replacing a media material filled in the slot;
re-determining the second identification of the slot with the replaced media material; and
clearing a first identification of the slot with replaced media material.

10. The method of claim 9, further comprising:
in response to detecting a touch on a third control of the slot by a user, cropping a media material filled in the slot;
keeping a second identification of the slot with cropped media material unchanged; and
clearing a first identification of the slot with cropped media material.

11. The method of claim 10, further comprising:
in response to detecting a touch on a fourth control of the slot by a user, replicating the slot and a media material filled in the slot;
re-determining a second identification of the replicated slot; and
clearing a first identification of the replicated slot.

12. The method of claim 11, further comprising:
in response to detecting a touch on a fifth control of the slot by a user, determining a first identification and a second identification of the added slot.

13. The method of claim 12, further comprising:
in response to detecting a touch on a sixth control by a user, playing the processed media material based on the freeze-frame combination, such that the freeze-frame media material in the media materials is continuously displayed for a period of time during play.

14. An electronic device, comprising:
a memory and a processor;
wherein the memory is configured to store one or more computer instructions which, when executed by the processor, cause the processor to:
obtain a first identification of each of a plurality of slots, each of the plurality of slots being used for filling a media material, the first identification being used for indicating whether respective slots belong to a same freeze-frame effect;
obtain a second identification of each of the plurality of slots, the second identification being used for indicating whether respective slots are filled with a same media material; and
determine, based on the first identification and the second identification, a freeze-frame combination for media materials, to play the media materials based on the freeze-frame combination, such that a freeze-frame media material in the media materials is continuously displayed for a period of time.

15. The device according to claim 14, wherein the instructions causing the processor to determine, based on the first identification and the second identification, the freeze-frame combination for the media materials comprise instructions causing the processor to:
in response to first identifications of the plurality of slots being consistent, determine a freeze-frame set based on the consistent first identification, the freeze-frame set consisting of a plurality of slots with the consistent first identifications; and
in response to media materials filled in the plurality of slots in the freeze-frame set comprising the freeze-frame media material, determine the freeze-frame combination for the media materials based on the freeze-frame set.

16. The device according to claim 14, wherein the instructions causing the processor to determine, based on the first identification and the second identification, the freeze-frame combination for the media materials comprise instructions causing the processor to:
in response to first identifications of the plurality of slots being inconsistent, determine whether the plurality of slots have consistent second identifications;
determine whether the media materials filled in the plurality of slots comprise the freeze-frame media material; and
in response to the plurality of slots having consistent second identifications and the media materials filled in the plurality of slots comprising the freeze-frame media material, determine a first group of slots.

17. The device according to claim 16, further comprising instructions causing the processor to:
traverse each slot in the first group of slots; and
in response to media materials filled in a plurality of slots of the first group of slots apart from a freeze-frame media material slot being temporally continuous, and in response to the plurality of slots of the first group of slots apart from the freeze-frame media material slot being continuous, and in response to second identifications of the plurality of slots of the first group of slots apart from the freeze-frame media material slot being consistent, merge the plurality of slots of the first group of slots into a freeze-frame set including the freeze-frame media material slot.

18. The device according to claim 17, further comprising instructions causing the processor to:
determine a starting time of a slot having a minimum timestamp in the freeze-frame set as a reference time; and
determine the starting time of each slot in the freeze-frame set based on the reference time.

19. The device according to claim 18, further comprising instructions causing the processor to:
determine the freeze-frame combination for the media materials based on the starting time of each slot and the freeze-frame set.

20. A non-transitory computer-readable medium comprising instructions stored thereon which, when executed by a processor, cause the processor to:
obtain a first identification of each of a plurality of slots, each of the plurality of slots being used for filling a media material, the first identification being used for indicating whether respective slots belong to a same freeze-frame effect;
obtain a second identification of each of the plurality of slots, the second identification being used for indicating whether respective slots are filled with a same media material; and
determine, based on the first identification and the second identification, a freeze-frame combination for media materials, to play the media materials based on the freeze-frame combination, such that a freeze-frame media material in the media materials is continuously displayed for a period of time.
